(19) United States
(12) Patent Application Publication
(10) Pub. No.: US 2009/0038010 A1
(43) Pub. Date: Feb. 5, 2009

(54) Monitoring and controlling an automation process

(75) Inventors: Yue Ma, Redmond, WA (US); Patrick J. Niemeyer, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/888,233

(22) Filed: Jul. 31, 2007

(51) Int. Cl. G06F 11/30

(52) U.S. Cl. 726/23

(57) ABSTRACT

Embodiments are provided to monitor aspects of a process, such as an automation process. In an embodiment, a system includes a number of components configured to monitor and validate operational aspects of a test automation process. In one embodiment, a monitoring application can be used to detect test automation issues, such as file related issues, registry related issues, network related issues, and other operational issues for example. The monitoring application can include a number of rule sets which may be tailored to identify and detect new types of exceptions and other conditions associated with an automation process or some other process. Other embodiments are available.

### BACKGROUND

Test automation can be used to automate a testing process. For example, a test automation process may test various use scenarios and configurations to determine the reliability of software or hardware before releasing the software or hardware to the public. However, transparent changes to a software or hardware state can influence a test, including subsequent tests and uses. For example, a test automation process may leave residues, such as registry keys, that cause subsequent tests to fail. As further example, a bad test may be misfiled as “Supported on configuration X” when, in reality, the test does not function correctly in configuration X. Subsequently, when that test is picked up by a lab query for “configuration X,” it may fail.

Consequently, additional, and often unwarranted, work can be created for users when attempting to determine operational issues associated with a test automation process. For example, a tester may have to be notified of a failed test, perform additional work to figure out why the test failed, mark the failure as investigated, and potentially have to correct any deficient aspect of the test (if ever determined). Even though a test does not fail directly, the test may alter a device configuration in such a way that subsequent tests fail. For example, a test could change the regional settings to some locale such that some later test reports a failure because the later test assumed the machine was in the proper configuration. Currently, a test owner of the later failed test may be forced to try and understand why the test failed. As a result, many man hours can be lost while inefficiencies mount, ultimately detracting from the value of a test automation process.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided to monitor aspects of a process, such as an automation process. In an embodiment, a system includes a number of components configured to monitor and validate operational aspects of a test automation process. In one embodiment, a monitoring application can be used to detect test automation issues, such as file related issues, registry related issues, network related issues, and other operational issues for example. The monitoring application can include a number of rule sets which may be tailored to identify and detect new types of exceptions and other conditions associated with a test automation process or some other process.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of a system configured for monitoring a process.

FIG. 2 is a block diagram of a system configured for monitoring a process.

FIG. 3 depicts a flow diagram which illustrates a monitoring process.

FIG. 4 is a block diagram illustrating a computing environment for implementation of various embodiments described herein.

### DETAILED DESCRIPTION

Embodiments are provided to monitor a process. In an embodiment, a system can be configured to monitor an automation process. In one embodiment, the system includes a monitor component that can be configured to monitor aspects of a test automation process, including providing detection data associated with operational aspects of hardware and software. The monitor component can include a number of monitors and associated rules that can be used to monitor and validate aspects of the test automation process. For example, the monitor component can be configured to provide runtime monitoring during automation to detect and manage state changes in test devices to reduce failures and future disruptions.

In another embodiment, a monitoring application can be configured to provide runtime monitoring during an automation process to detect state changes in test devices, including state changes in the device hardware and software. The monitoring application can use a detected state change when attempting to reduce a failure associated with the automation process or some other process. For example, during test execution, the monitoring application can be used to detect: whether a test modifies a device state (including hardware, software, middleware, component level, etc.); file or file system related operations; operating system related operations; network related operations; registry related operations; and, other operational aspects of test components. In other embodiments, the monitoring application can be used to implement an extensibility model for future enhancements, such as for future checks of other settings changes, folder/file monitoring capabilities, software validation, etc.

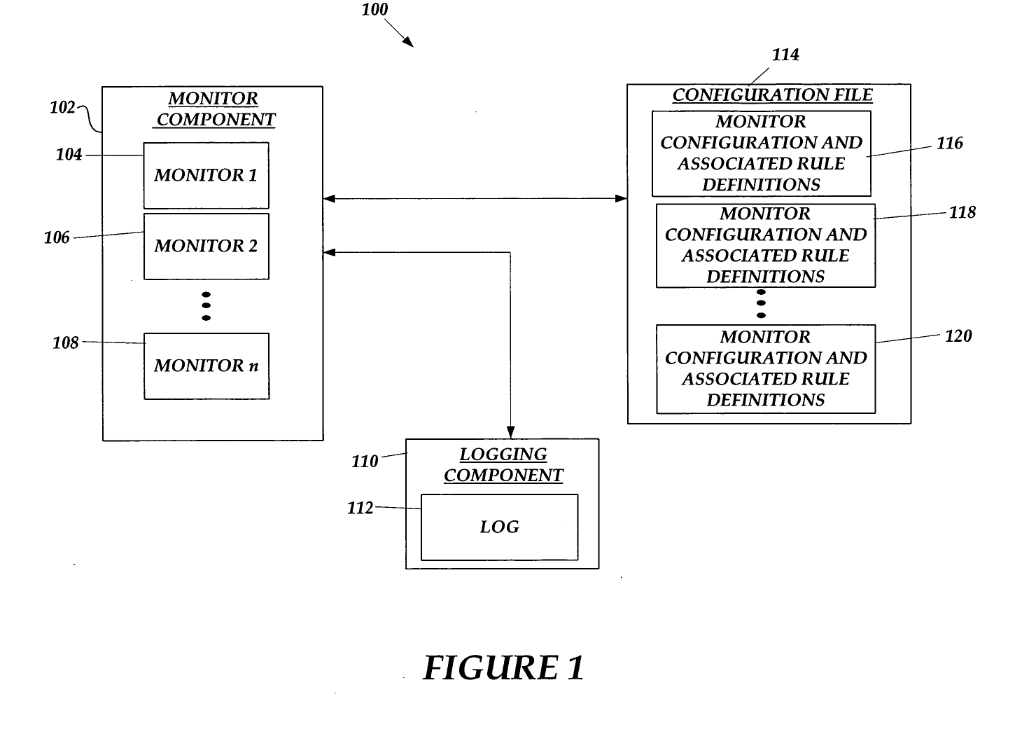

FIG. 1 depicts a system 100 that can be configured to monitor and validate aspects of an automation process, in accordance with an embodiment. In one embodiment, components of the system 100 can be configured as a monitoring application, such as a software program for example, that can be used to provide detection data as part of a monitoring and validation process. The system 100 can be configured as part of a networked monitoring system, wherein each networked computing device can include one or more components of the system 100 for use in monitoring and validating an automation process for example.

As described below, the system 100 includes a monitor component 102 having a number of monitors 104-108 that can be configured to run alongside an automation process. In one embodiment, the monitor component 102 can be configured as a user interface (UI) which can be used to define parameters, including monitors and associated rules, to be used as part of a monitoring process. While running, the monitors 104-108 can be used to detect rule violations and/or exceptions associated with a number of rules. For example, the system 100 can use rule behaviors to determine potential device and code issues as part of a test automation process. The system 100 can be configured to provide a collected approach to automation quality measures, including providing a number of mechanisms for defining rule behaviors.

The monitor component 102 can be configured to detect issues and parameters associated with a changing operational state or changed operational state of a device. The monitor component 102 can be included on each device associated with an automation process. The monitors 104-108 of the monitor component 102 can be tailored according to a desired monitoring and validation functionality. As described below, each monitor can include a number of associated rules that can be used as part of a monitoring and validation process. Moreover, the monitoring component 102 can use any number of monitors, including yet to be defined monitors, to detect operational issues as part of a monitoring process.

While operating, the monitor component 102 can operate to collect and log information associated with a particular monitoring process. The collected information can be communicated to a dedicated computing device, such as a central server for example, for further assessment. For example, the monitor component 102 can be used to: check software functionality and behavior; detect state changes to software or hardware so that a test does not transparently change the state of a device; detect file and file system operational issues; detect registry operational issues; detect operating system issues; and, monitor other aspects of an automation process. Accordingly, the monitor component 102 can be used to monitor operational aspects of a device to detect changes in hardware and software states during operation.

The monitor component 102 can be used to monitor a system, a device, an application, etc. to detect operational issues as part of an automation process. The monitor component 102 includes functionality to determine exceptions to one or more rules according to allowable device actions and/or operational states. In one embodiment, the monitor component 102 can perform a number of state based comparisons to detect allowable and prohibited actions. The monitor component 102 can also be used to provide information as part of an automation process. For example, the monitor component 102 can be configured to provide synchronous and/or asynchronous information as part of a test automation process.

The monitor component 102 can also be configured to provide auditing functionality. For example, the monitor component 102 can communicate with a test framework through a separate application when performing an audit. The monitor component 102 can query for information and gain access to needed resources, including ensuring that any required resources may be retrieved from one or more controlled data stores (e.g., file shares, web servers, network protocols, etc.) as part of an auditing process.

As shown in FIG. 1, the system 100 includes a logging component 110 that can be used to log detection data to an associated log 112. The log 112 can include detection data from a particular monitoring process. At a desired time, the detection data can be used to ascertain operational aspects, including undesirable software and hardware states, which may occur during a particular monitoring session. For example, the logging component 110 can be used to log detection data during a test automation run, and the detection data can be used to determine if any problems occurred while monitoring the run. Correspondingly, the detection data can be used to take corresponding action to fix issues, including potential issues, based in part on a number of rule exceptions that were detected by the monitor component 102. In one embodiment, the monitor component 102 can include the functionality of the logging component 110 to log information.

With continuing reference to FIG. 1, the system 100 includes a configuration file 114 that can be used to define a number of monitors and associated rule definitions 116-120 which can be used during an automation process. The configuration file 114 can be used to define monitor configurations and rule definitions to use when monitoring particular aspects of an automation process. The monitor component 102 can use the information as defined by the configuration file 114 when preparing to monitor and validate as part of an automation process or some other process.

Once defined, the monitor component 102 can use the configuration file 114 to load one or more monitors and associated rule definitions that can be used during an automation process. A monitor and associated rule definitions can be loaded dynamically at run-time. Additionally, the monitor component 102 can be configured to dynamically load any monitor(s) specified in a configuration file. In an embodiment, the configuration file 120 consists of an extensible markup language (XML) based data structure including a number of configuration parameters that can be tailored according to a particular monitoring session.

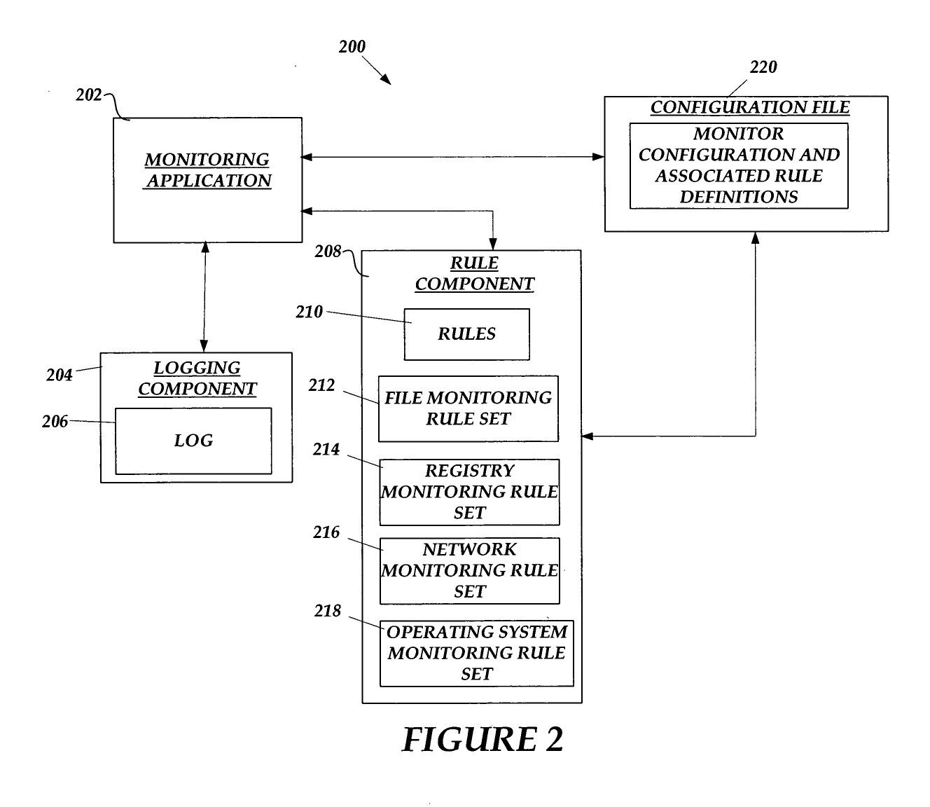

FIG. 2 depicts a system 200 that can be configured to monitor and validate aspects of an automation process, such as aspects of a test automation process for example. As described below, the system 200 can include a number of validation engines or monitors that can run alongside an automation process to determine issues, including potential issues, and violations against a defined number of rule sets. The system 200 can be configured to provide a collected approach to automation quality measures, including employing a number of mechanisms for defining and implementing desired rule behaviors. In one embodiment, aspects of the system 200 can be extended using a programming language (e.g., .NET programming with reflection, C#, a .NET Framework, etc.).

As shown in FIG. 2, the system 200 includes a monitoring application 202 that can be configured to assess issues, actions, and parameters associated with a changing or changed device state, including software and hardware states. For example, the monitoring application 202 can be used to assess device states, including software and hardware operational states, as part of a test automation monitoring process. The monitoring application 202 can be configured as a software program, including executable instructions, that can be included on one or more devices that are associated with an automation process.

As described below, the monitoring application 202 can be used to monitor and/or log information associated with a particular monitoring session. Thereafter, the collected information can be communicated to a dedicated computing device, such as a central server for example, for further assessment. Alternatively, the collected information can be assessed as part of an assessment of the monitored device. The monitoring application 202 can also be configured to include restoration functionality that can operate to restore a device to a prior state, such as a default configuration for example.

In one embodiment, the monitoring application 202 can be used to: check software functionality and behavior; ensure that a test does not transparently change the state of a device; detect file or file system related operations; detect operating system related operations; detect network related operations; detect registry related operations; and, monitor other operational aspects of a device, system, or component. For example, the monitoring application 202 can be used to monitor a state of a handheld computing device to detect changes as part of a screen orientation test, such as from a portrait configuration to a horizontal landscape configuration. The test may be used to verify that the screen state can be changed from a default portrait configuration to a horizontal landscape configuration. Correspondingly, the monitoring application 202 can be used to ensure that the test returns the screen state back to the default configuration by determining if one or more rule exceptions have been triggered during the test.

As described further below, the monitoring application 202 includes a number of rule sets or monitors, and associated rules that can be used to monitor and validate a system, a device, an application, etc. The rule sets and associated rules can be used to detect parameter and other changes to provide detection data. The monitoring application 202 includes a core or runtime component that can be used to execute aspects of the monitoring application 202 including loading rule sets and sub-sets, loading rule definitions, and/or providing for an integrating with logging features to log information. In one embodiment, the monitoring application 202 can perform a number of state-based comparisons to detect allowable and prohibited actions according to a number of defined rules. For example, the monitoring application 202 includes functionality to define allowable device actions or states based in part on a number of pre-defined rules.

The monitoring application 202 can be used to provide synchronous and asynchronous information as part of a monitoring session. For example, the monitoring application 202 can be used to report synchronous results with test scenario execution (e.g., “file x was touched . . . ”) and/or asynchronous device state deltas at the end of the test (e.g., “the display color depth changed from 8 bits per pixel to 6”). Additionally, the monitoring application 202 can be configured to perform audits to ensure that any required resources can be retrieved from one or more controlled data stores (e.g., file shares, web servers, network protocols, etc.).

As shown in FIG. 2, the system 200 includes a logging component 204 that the monitoring application 202 can use to log detection data to a log 206 that can be associated with a particular monitoring session. At a desired time, the detection data can be used to review aspects of the particular monitoring session. In another embodiment, the monitoring application 202 can include the functionality of the logging component 204. For example, the logging component 204 can be used as part of the collecting of detection data during a test automation run. Thereafter, the detection data can be used to determine what actually happened while monitoring the run with the monitoring application 202. The detection data can be used to assess operational aspects of an automation process. Moreover, the detection data can be used to take corresponding action to fix any issues, such as issues associated with a number of rule exceptions for example, that are detected by the monitoring application 202.

With continuing reference to FIG. 2, the system 200 also includes a rule component 208 that includes a number of rules 210 that can be used by the monitoring application 202 for a monitoring task or session. The rules 210 can be included as part of the functionality of an associated monitor that is being used by the monitoring application 202. While certain numbers and types of rules are shown and discussed, the system 200 can include fewer or more rules according to a desired implementation.

As shown, the system 200 includes a number of rules sets or monitors that include: a file monitoring rule set 212, a registry monitoring rule set 214, a network monitoring rule set 216, and an operation system monitoring rule set 218. Accordingly, each rule set 212-218 can be tailored to provide a particular type of monitoring functionality to assess a potential issue. Moreover, each rule set 212-218 can include a number of different rule sub-sets and associated parameters. Other rule sets are available and can be included as part of the system 200. Moreover, the system 200 is extensible and new rule sets can be defined and added to the system 200.

The file monitoring rule set 212 includes a number of rules that are configured to monitor file related events and/or actions. In an embodiment, the file monitoring rule set 212 can be configured to identify file associated operations, such as access to files on disk or report summary data about files which have been created, deleted, altered, etc. As another example, the file monitoring rule set 212 can be used to: detect when a file has been created but not saved or deleted; detect if a file was unintentionally deleted or renamed; detect changes in file states; ignore changes made to a newly created file; and, support single directory monitoring or recursive directory monitoring.

In one embodiment, the file monitoring rule set 212 can be configured to record a file or file system state at certain times, such as at a start of a monitoring session and at a conclusion of the monitoring session for example. The monitoring application 202 can perform a difference or delta operation to determine how file or file system parameters have been affected during the monitoring session. In another embodiment, the file monitoring rule set 212 can be configured to record file or file system states throughout or at desired times during a monitoring session.

The registry monitoring rule set 214 includes a number of rules that are configured to monitor registry related events and/or actions. In an embodiment, the registry monitoring rule set 214 can be configured to identify registry associated operations, such as identifying registry modifications for example. The registry monitoring rule set 214 can also provide summary data concerning overall changes to a registry which occur during a monitoring session, including atypical registry events. For example, the registry monitoring rule set 214 can be used to: detect whether a registry key or value is deleted; detect whether a registry key or value was created but not deleted; detect whether a registry key or value that was changed; and, support single key monitoring or recursive key structure monitoring.

In one embodiment, the registry monitoring rule set 214 can be configured to record a registry state at certain times, such as at a start of a monitoring session and at a conclusion of the monitoring session for example. The monitoring application 202 can perform a difference or delta operation to determine how the registry has been affected during the monitoring session. In another embodiment, the registry monitoring rule set 214 can be configured to record registry states throughout or at desired times during a monitoring session.

The network monitoring rule set 216 includes a number of rules that are configured to monitor network related events and/or actions. In an embodiment, the network monitoring rule set 216 can be configured to identify network associated operations. For example, the network monitoring rule set 216 can be used to: identify which network devices have been used; detect transferred packets (e.g., TCP, FTP, HTTP, UNC, etc.) including information associated with sent/received packets; facilitate audits of accessed network resources; ignore a server connection that is not unique by keeping track of a unique list of servers that are accessed; and, help prevent unreliable network access.

In one embodiment, the network monitoring rule set 216 can be configured to record a network state at certain times, such as at a start of a monitoring session and at a conclusion of the monitoring session for example. The monitoring application 202 can perform a difference or delta operation to determine how network parameters have been affected during the monitoring session. In another embodiment, the network monitoring rule set 216 can be configured to record network states throughout or at desired times during a monitoring session.

The operation system monitoring rule set 218 includes a number of rules that are configured to monitor operating system events and/or actions. In an embodiment, the operation system monitoring rule set 218 can be configured to identify operating system associated operations. For example, the operation system monitoring rule set 218 can be used to identify operations that alter aspects of an operating system machine state, such as display resolution, locale settings, time zone, etc.

In one embodiment, the operation system monitoring rule set 218 can be configured to record an operating system state at certain times, such as at a start of a monitoring session and at a conclusion of the monitoring session for example. The monitoring application 202 can perform a difference or delta operation to determine how operating system parameters have been affected during the monitoring session. In another embodiment, the operation system monitoring rule set 218 can be configured to record operating system states throughout or at desired times during a monitoring session.

The various rule sets 212-218 can be customized using a simple or a complex set of parameters for processing. For example, simple rule processing can include the use of logical predicates to evaluate and control what should be treated as a rule violation. On the other hand, complex rules can include arbitrarily complex logic for monitor configurations, wherein various rule settings can be passed to the monitoring application 202 to parse. For example, the file monitoring rule set 212 can be used to monitor a file system by using simple rule processing to establish a set of paths where file system changes are considered important and only associated file system changes will be logged as rule violations. As further example, the file monitoring rule set 212 can be used to monitor a file system using more complicated logic to set regular expressions or provide another parsing engine to establish a set of paths or file types, or file size constraints.

When executed at runtime, the monitoring application 202 can use a number of defined monitors or rule sets according to a type of monitoring preferred for a monitoring session. As described below, a configuration file 220 can be used to define a rule set configuration for one or more rule sets. In an embodiment, the configuration file 220 consists of an XML based data structure including a number of configuration parameters that can be tailored according to a particular monitoring session. For example, an XML-based configuration file 220 can be used to tune a monitoring session such as by specifying multiple rule sets for a detailed assessment of a test automation process. As further example, an XML-based configuration file 220 can be defined to include a select number of rules focusing on particular system component or code as background verifications associated with a test automation process.

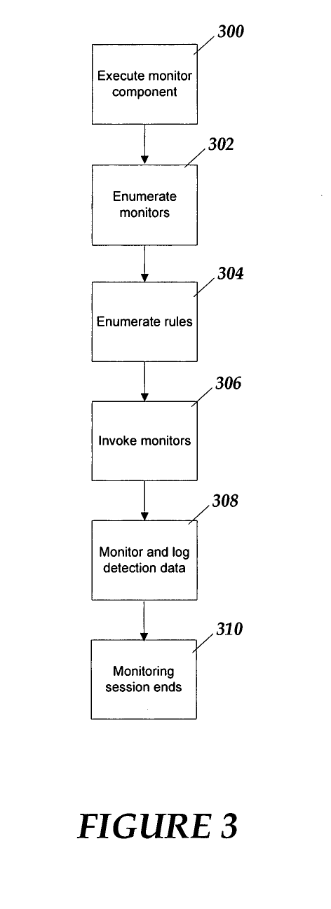

FIG. 3 is flow diagram illustrating a monitoring process, under an embodiment. The components of FIG. 1 are used in the description of FIG. 3, but FIG. 3 is not so limited. At 300, the monitor component 102 is executed as part of an automation process, such as a test automation process for example. The execution of the monitor component 102 invokes the runtime. At 302, the monitor component 102 uses an associated configuration file 114 to enumerate a number of monitors associated with the monitoring session, making the monitors available to the runtime. At 304, the monitor component 102 uses the configuration file 114 to enumerate a number of rules to be used for the monitoring session.

In one embodiment, a number of rules can be selected based in part on the number of enumerated monitors and/or type of monitoring session. The rule enumeration may affect the runtime and individual rules. Accordingly, runtime rule settings may be used to enforce different rules using the same configuration file 114 for different monitoring sessions. For example, it may be desirable to enforce some rules based on time (establishing rule expiration), job creator (customizing rules for lab personnel or individual users), job purpose (official vs. ad hoc run purposes), etc. The runtime may also be configured to treat certain types of rule violations as errors, warnings, or comments when communicating with the logging component 110.

Once the monitors and associated rules are enumerated, at 306, the monitor component 102 invokes the enumerated monitors and associated rules. At 308, the logging component 110 logs (e.g., OTS logging) events or actions based on rule exceptions or other identified parameters associated with the monitoring session. At 310, the monitoring session ends. As part of the clean-up at session end, the monitor component 102 can perform post-processing operations to make sure any rules that require post-processing are performed (e.g., parameter comparing). It can also perform any comparison and then another post-processing to make sure all of the log entries are logged. It should be noted that asynchronous monitors can be used to log results throughout the monitoring session. Synchronous monitors can use a shut-down loop to clean-up the associated routines.

The example below illustrates the use of the monitoring component 102 to monitor aspects of an automation process during a monitoring session. A user has created a new test and wants to make sure the test is robust. The user identifies which monitors and associated rules to run with the test which are then stored in the configuration file 114. The user selects monitors and rules that can detect each file that gets touched and each registry key that gets modified during test execution. Since the rules may return an excessive amount of data, the user decides to place limitations on the selected rules. For example, the user may decide to look for one file-based scenario and ten registry-based scenarios by limiting the number of rule parameters. Furthermore, the user may decide to run a large number of tests against one monitor and one rule according to preference.

New monitors and rules can be added to the systems described above and included in a configuration file for use by a monitor component or application. Additionally, multiple configuration files can be created and selectively used for different types of monitoring scenarios. For example, configuration files can include different rule sets for detailed and simple analysis, which can be used to control the amount of time to monitor, and the amount of detection and log data.

In an embodiment, a schema can be used to define a configuration file. The schema can be used to define parameters associated with a number of parameters and rules. In one embodiment, the schema can be configured as follows:

```
    <autocop coreversion=“12.0.3000.1000”>
      <ruleset expire=“Month/Day/Year″ name=“Rule Set Name”>
          <applicability>
              <when contextpath=“Path″ value=“Value″/>
              <except contextpath=“Path″ value=“Value″/>
          </applicability>
          <rules>
              <simplerule  type=“assembly  name”
logviolationsas=“error”>text</simplerule>
              <complexrule type=“assembly name”
              logviolationsas=“error”>
                  <custom1 type=“This is a custom tag”>custom tag
1</custom1>
              </complexrule>
          </rules>
      </ruleset>
    </autocop>
```

In another embodiment, a schema can be used to define a different configuration as follows:

```
    <autocop coreversion=“12.0.3000.1000”>
  - <ruleset expire=“09/30/2007” name=“Set1”>
  <applicability />
  - <rules>
  <simplerule  type=“Microsoft.OASys.AutoCop.Rules.FileMonitor”
logviolationsas=“error”>C:\*</simplerule>
  <simplerule  type=“Microsoft.OASys.AutoCop.Rules.FileMonitor”
logviolationsas=“error”>D:\*</simplerule>
  <simplerule  type=“Microsoft.OASys.AutoCop.Rules.FileMonitor”
logviolationsas=“error”>E:\*</simplerule>
  <simplerule  type=“Microsoft.OASys.AutoCop.Rules.FileMonitor”
logviolationsas=“error”>F:\*</simplerule>
  <simplerule  type=“Microsoft.OASys.AutoCop.Rules.NetMonitor”
logviolationsas=“error”>no param</simplerule>
  <simplerule  type=“Microsoft.OASys.AutoCop.Rules.RegMonitor”
logviolationsas=“error”>HKCU\*</simplerule>
  <simplerule  type=“Microsoft.OASys.AutoCop.Rules.RegMonitor”
logviolationsas=“error”>HKLM\System\*</simplerule>
  <simplerule  type=“Microsoft.OASys.AutoCop.Rules.RegMonitor”
logviolationsas=“error”>HKLM\Software\Microsoft\Internet
Explorer\*</simplerule>
  <simplerule  type=“Microsoft.OASys.AutoCop.Rules.RegMonitor”
logviolationsas=“error”>HKLM\Software\Microsoft\Office\*</simplerule>
  </rules>
  </ruleset>
  </autocop>
```

In various embodiments, components of the systems 100 or 200 can be implemented as part of a client/server computing environment, wherein each computing device can include a monitoring application and logging functionality to monitor an associated device during a monitoring process. Logged detection data can be uploaded to a server for further processing. Moreover, the server can be used to download the monitoring application and updates, store configuration files, and download a configuration file to a device that is to be used during a monitoring process. The server can also download updates to a configuration file. Additionally, a user can interact with the server to modify a configuration file, which can then be communicated to users associated therewith.

A computing environment can be described as a network or collection of components wherein the associated components are communicatively coupled in such a manner to provide an operational functionality. Each computing device of a computing environment can include networking and security components configured to provide communication functionality to and from respective components of the associated computing environment. For example, a computing environment can include wireless local area networks (WLANs), local area networks (LANs), wide-area network (WANs), combinations thereof, and/or other types of computing and/or communication networks. In one embodiment, a computing environment can be configured as is a distributed computer network that allows one or more computing devices, communication devices, etc., to communicate when monitoring as part of an automation process.

Exemplary computing devices can include desktop computers, laptop computers, tablet computers, handheld devices, and other communication devices. Components of a computing environment can be communicatively coupled using wired, wireless, combinations of wired and wireless, and other communication techniques. The monitoring functionality can also include combinations of various communication methods.

As described above, a system includes a number of monitors that can be configured to detect state changes of a device, software, or some other parameter. For example, a monitor can be configured to detect a change in a regional setting such as changing the decimal. Monitors can also be configured to provide monitoring functionality for any system setting, such as display settings, palette settings, etc. Other embodiments and monitoring functionality are available.

### Exemplary Operating Environment

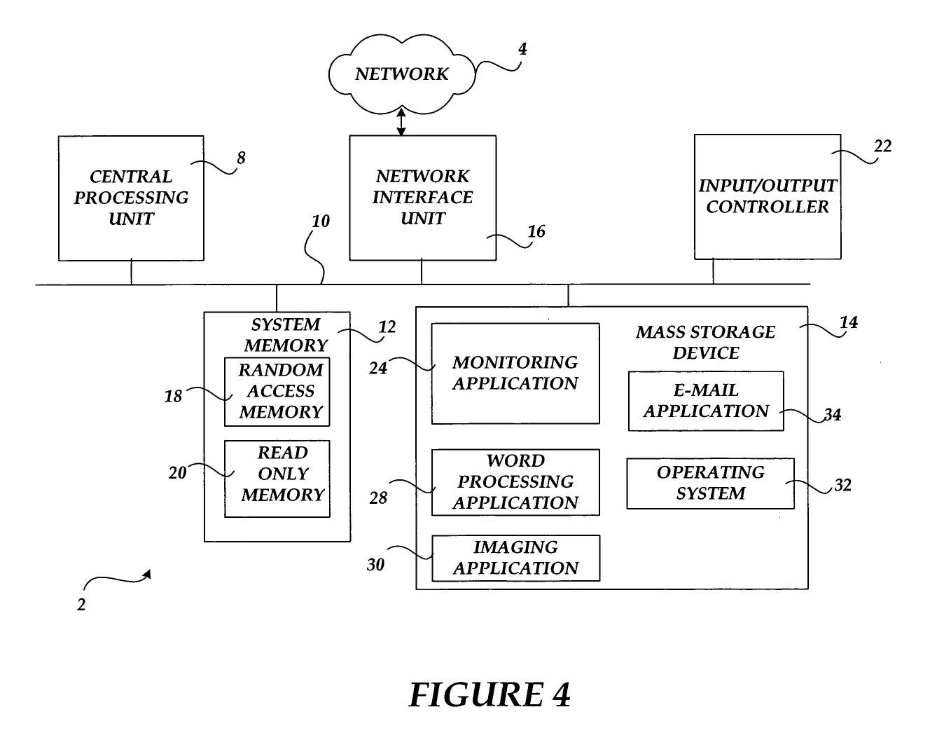

Referring now to FIG. 4, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 4, an illustrative operating environment for embodiments of the invention will be described. As shown in FIG. 4, computer 2 comprises a general purpose desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 32, application programs, and other program modules.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of input types, including a keyboard, mouse, pen, finger, and/or other means. Similarly, an input/output controller 22 may provide output to a display, a printer, or other type of output device. Additionally, a touch screen can server as an input and an output mechanism.

As mentioned briefly above, a number of program modules and data files may be stored in the mass storage device 14 and RAM 18 of the computer 2, including an operating system 32 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as a monitoring application 24, word processing application 28, an imaging application 30, e-mail application 34, drawing application, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer readable medium including executable instructions which, when executed, monitor information by:
selecting one or more monitors to use as part of monitoring a number of devices associated with an automation process, wherein the one or more monitors can be used to detect a number of operational parameters associated with the number of devices;
defining a number of rules to be used by the one or more monitors when monitoring the number of devices, wherein the number of rules can be tailored for the one or more monitors to determine device actions during the automation process;
invoking the one or more monitors including the defined number of rules while monitoring the number of devices, wherein the one or more monitors can provide detection data associated with the device actions; and,
logging the detection data to a log.

2. The computer-readable medium of claim 1, wherein the instructions, when executed, monitor information by monitoring operational aspects of a test automation process.

3. The computer-readable medium of claim 1, wherein the instructions, when executed, monitor information by modifying one or more of the number of rules to assess an operational state of one or more of the number of devices.

4. The computer-readable medium of claim 1, wherein the instructions, when executed, monitor information by monitoring an operational state of one or more of the number of devices at a beginning and at an end of the automation process.

5. The computer-readable medium of claim 4, wherein the instructions, when executed, monitor information by comparing the beginning operational state with the ending operational state of the one or more of the number of devices to determine an occurrence of a rule exception.

6. The computer-readable medium of claim 1, wherein the instructions, when executed, monitor information by performing a number of state-based comparisons to detect operational issues associated with one or more of the number of devices.

7. The computer-readable medium of claim 1, wherein the instructions, when executed, monitor information by using the detection data to minimize subsequent automation issues.

8. The computer-readable medium of claim 1, wherein the instructions, when executed, monitor information by evaluating detection data to determine allowable and prohibited device actions.

9. The computer-readable medium of claim 1, wherein the instructions, when executed, monitor information by using a file monitoring rule set to detect file related issues during the automation process.

10. The computer-readable medium of claim 1, wherein the instructions, when executed, monitor information by using a registry monitoring rule set to detect registry related issues during the automation process.

11. The computer-readable medium of claim 1, wherein the instructions, when executed, monitor information by using a network monitoring rule set to detect network related issues during the automation process.

12. The computer-readable medium of claim 1, wherein the instructions, when executed, monitor information by using an operating system rule set to detect operating system related issues during the automation process.

13. The computer-readable medium of claim 1, wherein the instructions, when executed, monitor information by synchronously monitoring one or more of the number of devices.

14. The computer-readable medium of claim 1, wherein the instructions, when executed, monitor information by asynchronously monitoring one or more of the number of devices.

15. A system configured to monitor information comprising:
a monitor component having a number of monitors and an associated number of rules, wherein the number of rules can be defined in a configuration file and can be used to assess an aspect of an automation process, and the number of monitors can provide detection data based in part on a rule exception; and,
a logging component to log the detection data to a log.

16. The system of claim 15, wherein the number of monitors further comprise a file system monitor, a network monitor, a registry monitor, or an operating system monitor.

17. The system of claim 15, wherein the monitor component and log are included on each device associated with the automation process.

18. A method of monitoring an automation process comprising:
defining a number of rule sets to be used when monitoring aspects of the automation process, wherein the number of rule sets can include a number of defined rules, including simple and complex rule parameters, directed to particular aspects of the automation process;
invoking one of more of the number of rule sets to monitor an operational state of hardware or software associated with the automation process, wherein the one or more of the number of rule sets can be used to provide detection data associated with the operational state of the hardware or the software; and,
logging the detection data.

19. The method of claim 18, further comprising detecting allowable and prohibited actions according to the number of defined rules, wherein the allowable and prohibited actions can be file related, network related, registry related, or operating system related.

20. The method of claim 18, further comprising performing an audit to ensure that a required resource for the automation process is available.
